(19) United States
(12) Patent Application Publication
(10) Pub. No.: US 2008/0289379 A1
(43) Pub. Date: Nov. 27, 2008

(54) SELF-LOCKING CYLINDER LOCK

(75) Inventor: Peter Martin, Bradenton, FL (US)

Correspondence Address: GIFFORD, KRASS, SPRINKLE,ANDERSON & CITKOWSKI, P.C, PO BOX 7021, TROY, MI, 48007-7021, US

(73) Assignee: Chateau Products, Inc., Bradenton, FL (US)

(21) Appl. No.: 11/752,786

(22) Filed: May 23, 2007

(51) Int. Cl. E05B 9/04

(52) U.S. Cl. 70/375

(57) ABSTRACT

A self-locking removable plug cylinder lock not requiring a key for the lock to be inserted into a latch aperture and secured in a locked position is provided. The lock includes a cylindrical tumbler-key plug and a locking pin positioned in a generally normal direction to an axial axis of the tumbler-key plug. The locking pin is operable to move in a generally radial inward direction without the use of a key when the plug lock is inserted into a latch aperture.

### FIELD OF THE INVENTION

This invention relates generally to a cylinder lock. More specifically, the invention relates to a self-locking cylinder lock.

### BACKGROUND OF THE INVENTION

The use of locks to store and protect household, office, personal and other items of the like is commonplace. For example, walk-in storage units use a lock to prevent individuals without a key from opening of a storage unit door. A sliding bolt mechanism is typically secured to the door and has a tongue member that extends beyond and sometimes into a doorjamb when the door is closed. One type of lock that can be used with such a sliding bolt mechanism is a cylinder lock, sometimes referred to as a plug lock. The cylinder lock can be inserted into an aperture within the sliding bolt mechanism and prevent the tongue member extending beyond the doorjamb from being retracted. Likewise, the cylinder lock can be removed from the sliding bolt mechanism, thereby allowing the tongue member to retract, by inserting and rotating a key within the lock.

However, rotation and insertion of the key within the cylinder lock can be cumbersome. For example, metal roll Lip doors commonly used in the construction of self storage units move freely within channels on either side of the doorway. The doors are typically of the “roll up” style with an overhead spring, and when pulled in a downward direction unroll and travel down the two channels mounted on each side of the door frame. After being pulled down into a closed position, a latch tongue is engaged into the door channel or frame. Yet given the flexibility requirements of a door that can roll up and roll down, insertion of a cylinder lock into a latch hole of such a door can be challenging for a user. Even more so, the cylinder lock requires evenly applied pressure from the key within the cylinder lock key way in order to lock and unlock the cylinder. Thus a handful of keys or a large key ring can create a difficult task for a user attempting to insert and lock a cylinder lock into the door. In addition, when used with outdoor storage units, weather elements such as rain, snow and the like can make such an operation even more difficult. Therefore, there is a need for a self-locking cylinder lock wherein a key is not required in order to insert the lock into a bolting mechanism aperture and secure the mechanism and door in a locked position.

### SUMMARY OF THE INVENTION

A self-locking removable cylinder lock not requiring a key for the lock to be inserted into a latch aperture and secured in a locked position is provided. The lock includes a cylindrical tumbler-key plug and a locking pin positioned in a generally normal direction to a central axial axis of the tumbler-key plug. The locking pin is operable to move in a generally radial inward direction without the use of a key when the cylinder lock with the locking pin is inserted into a latch aperture. The locking pin is also operable to move in a generally radial outward direction when the locking pin exits the lock aperture. The locking pin is spring loaded with a spring that applies a force on the locking pin in a generally outward direction and yet allows the locking pin to retract when force is exerted in a generally inward direction on the pin.

The locking pin has an external end with an arcuate surface that affords for the movement of the locking pin in a generally inward direction when the lock is inserted within the latch aperture. The external end of the locking pin also has a catch surface. The catch surface prevents removal of the lock from the latch aperture once the lock is inserted within the aperture and the locking pin exits a rearward end. The catch surface can be L-shaped with generally flat surfaces that engage rearward end surfaces of the latch aperture and prevent removal of the lock.

The locking pin also has an internal end with a spring aperture operable to accept the spring. Between the external end and internal end of the locking pin, a retraction pin slot is included that can accept a retraction pin. The retraction pin is part of a keyed tumbler mechanism that upon rotation retracts the locking pin in a generally inward direction towards the axial axis.

The cylinder lock has a stationary mechanism that prevents rotation once placed and secured within the latch aperture. One embodiment of the present invention uses a stationary mechanism that includes a first flat region on the outer wall of the lock that is generally parallel with a second flat region on the inner wall of the latch aperture once the lock is inserted within the aperture.

### BRIEF DESCRIPTION OF THE DRAWINGS

FIG. 1 is a perspective view of the inventive lock being placed into a latch mechanism;

FIG. 2 is a perspective view of a key;

FIG. 3 is an exploded perspective view of one embodiment of the present invention;

FIG. 4 is a perspective view showing an internal end of a locking pin;

FIG. 5 is a perspective view showing an external end of a locking pin;

FIG. 6 shows an assembly of two locking pins;

FIG. 7 is a front view of the locking pin assembly in FIG. 6 inserted into a latch aperture;

FIG. 8 is a front view of the pin assembly shown in FIG. 6 inserted into a latch aperture with rotation of a retraction pin;

FIG. 9 is a cross-sectional view of section 9-9 shown in FIG. 6;

FIG. 10A is a cross-sectional view of the insertion of the locking pin into a latch aperture;

FIG. 10B is a cross-sectional view of the insertion of the locking pin into a latch aperture;

FIG. 10C is a cross-sectional view of the insertion of the locking pin into a latch aperture; and

FIG. 11 is a cross-sectional view of the retraction of a locking pin.

### DETAILED DESCRIPTION OF THE INVENTION

The present invention comprises a simple to use self-locking removable cylinder lock not requiring a key for the lock to be inserted into a latch aperture and secured in a locked position. As such, the present invention has utility as a lock for providing convenience to and protection of items for a user. The lock of the present invention is a cylinder lock with a cylindrical tumbler-key plug and a locking pin operable to move in a generally radial inward direction without the use of a key when the lock is inserted into a lock aperture. The locking pin can also move in a generally radial outward direction when the locking pin exits the latch aperture. The locking pin can be spring-loaded with a spring that affords for the pin to remain in an extended position unless retracted with the use of a key or pushed upon with a force.

Referring now to FIG. 1, there is shown a perspective view wherein a self-locking removable cylinder lock 10 can be inserted into a latch aperture B within the latch A. The lock 10 has a locking pin 300 and a flat surface region 230. The flat surface region 230 is generally parallel to and adjacent to a flat aperture surface C within the latch aperture B when the lock 10 is inserted therein. A key 101 as shown in FIG. 2 can be used to retract the locking pin 300 in a generally inward direction and allow removal of the lock 10 from the latch aperture B. Removal of the lock 10 from the latch aperture B allows for the bolting mechanism D to be removed from a doorjamb E.

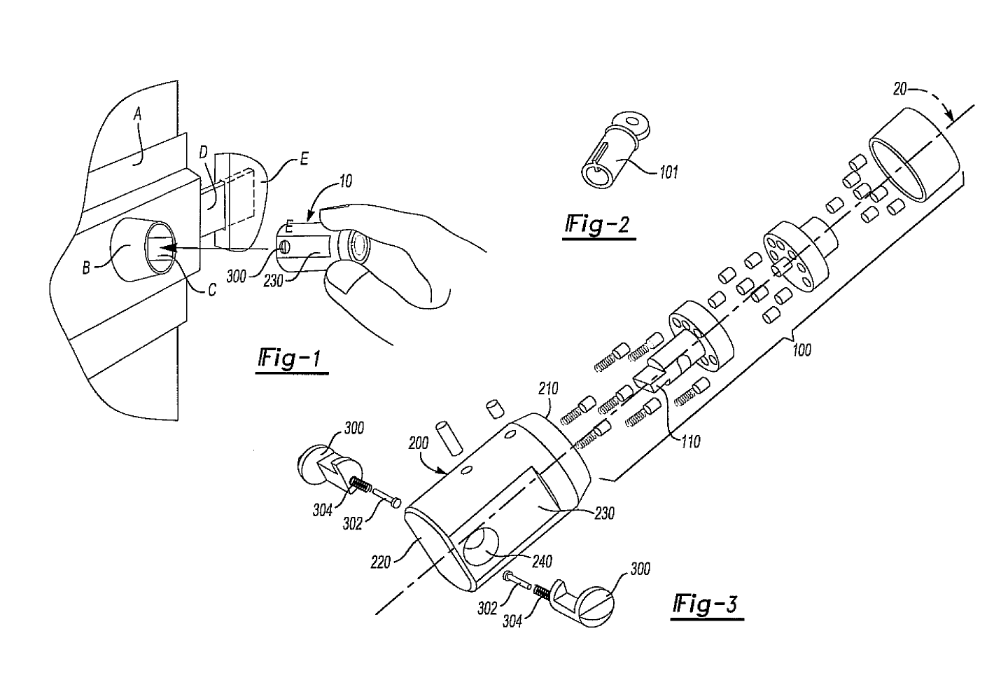

Turning now to FIG. 3, an exploded perspective view of the lock 10 is shown. The lock 10 has a central axial axis 20, a key tumbler mechanism 100 and a tumbler-key plug 200. The key tumbler mechanism 100 affords for the insertion of key 101 therein and rotation of retraction pin 110.

The tumbler-key plug 200 has a front end 210, a rear end 220 and at least one flat plug surface 230. Within the flat plug surface 230 is a pin aperture 240 wherein at least one locking pin 300 can fit within. The locking pin 300 includes a push pin 302 and a spring 304.

An enlarged perspective view of a locking pin 300 is shown in FIGS. 4 and 5. The locking pin 300 has an internal end 310 and an external end 320. The internal end 310 is preferably located within the tumbler-key plug 200 and the external end 320 can extend in a generally outward direction from axis 20 beyond the flat surface 230. The external end 320 has an arcuate surface 322 and a catch surface 328. The catch surface 328 includes a radial surface 324 and an axial surface 326. The radial surface 324 and axial surface 326 form a generally L-shaped surface. The radial surface 324 and axial surface 326 are preferably flat. The internal end 310 includes a spring aperture 312 wherein push pin 302 and spring 304 can be inserted.

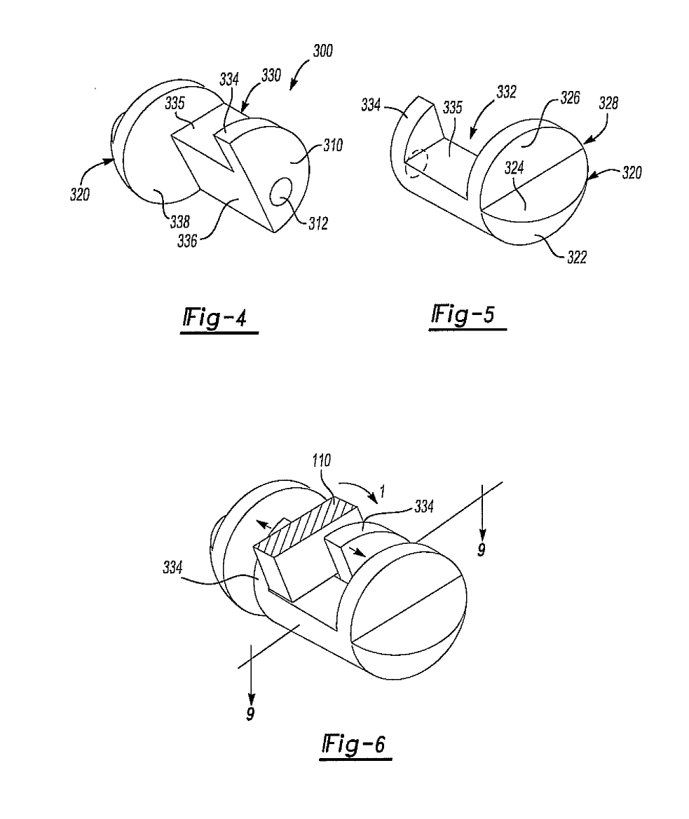

Between tie internal end 310 and external end 320 is a body 330. The body 330 can include a variety of shapes and cutouts wherein a retraction pin slot 332 is formed. In the embodiment shown in FIGS. 4 and 5, the retraction pin slot 332 includes a retraction tab 334, radial surface 335 and axial surface 338. Within the retraction pin slot 332 the retraction pin 110 can be accepted as shown in FIG. 6. In addition to the retraction pin slot 332, the locking pin 300 can include a radial surface 336 which affords for the matching of two locking pins 300 against each other as shown in FIG. 6 and insertion of said pins 300 within the locking pin aperture 240 as illustrated in the figures. In the alternative, only one pin 300 can provide for a locking mechanism as disclosed herein, in which case a radial surface 336 is not required. When two locking pins 300 are employed, the retraction pin 110 is bounded by the retraction tabs 334 of each pin 300, as illustrated in FIG. 6. In combination with the rotation of pin 110, e.g. by insertion of key 101 into key tumbler mechanism 100 and rotation thereof, the two retraction tabs 334 afford for the movement of external end 320 of locking pin 300 in a generally radial inward direction as illustrated in FIG. 6.

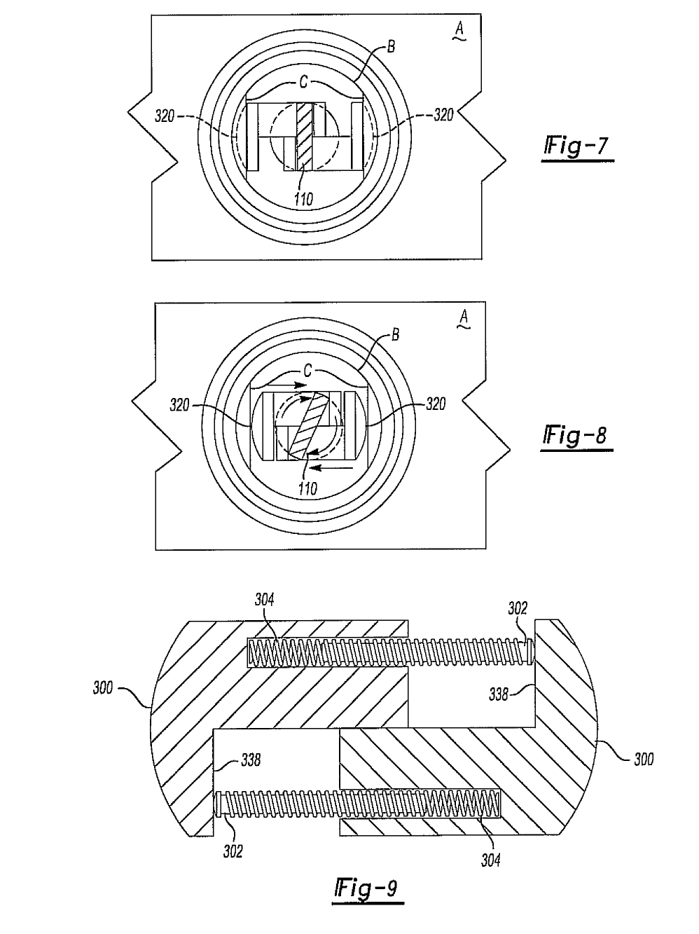

Turning to FIGS. 7 and 8, the operation of the locking pin mechanism from a front view is shown. In FIG. 7 the lock 10 is in a locked position with locking pin 300 extended. With the locking pin 300 extended, the arcuate surfaces 332 of the external end 320 extend beyond the surface C of the latch aperture B and thereby afford for catch surfaces 328 to engage a rearward surface of the latch aperture B. Preferably, the catch surfaces 328 engage exit surfaces of the flat surfaces C of latch aperture B. Turning to FIG. 8, the retraction of the locking pins 300 and movement of the arcuate surfaces 322 to a location within the flat surfaces C of the aperture B, is afforded by the rotation of the retraction pin 110 within the retraction pin slot 332.

FIG. 9 shows a cross-sectional view of section 9-9 in FIG. 6. This figure illustrates the use of push pin 302 and spring 304 to provide a generally outward force on the locking pin 300. It can be seen from this figure that the locking pin 300 remains in an extended position when not retracted with the use of the key 101 or pushed upon by a force in a generally inward direction.

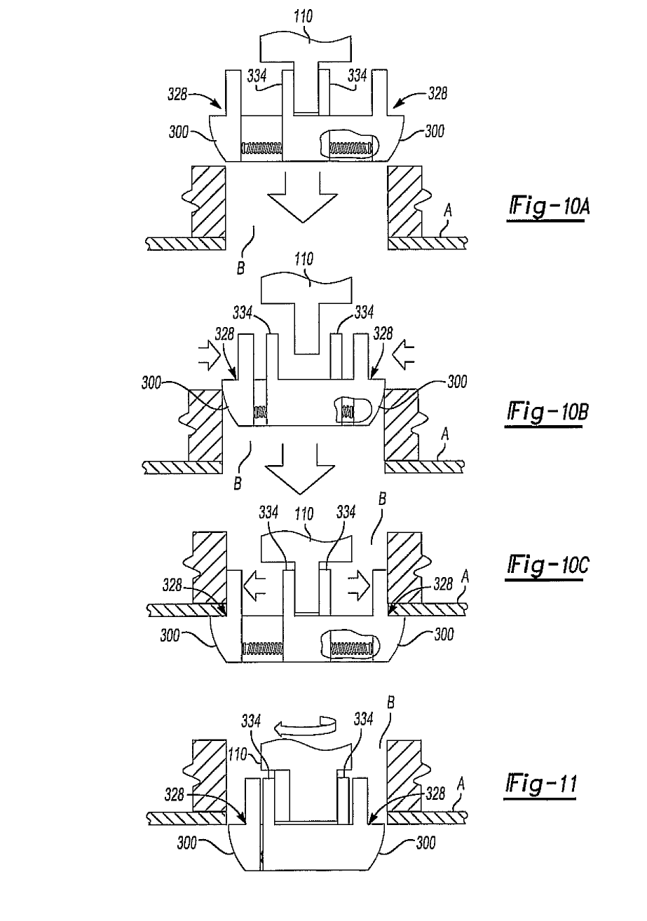

A side view of the operation of the locking mechanism of the present invention is illustrated in FIGS. 10A, 10B and 10C. FIG. 10A illustrates the position of the locking pins 300 before insertion of lock 10 into the latch aperture B of latch A. As shown in FIG. 10A, locking pins 300 are in an extended position and held in place with the use of retraction pin 110 and retraction tabs 334. Upon movement of the lock 10 within the latch aperture B, the arcuate surfaces 322 of the locking pins 300 have a force exerted thereon in a generally inward direction, as illustrated in FIG. 10B. This force affords for the movement of the locking pins 300 in a generally inward direction and allows for the lock 10 to slide into the latch aperture B. When the lock 10 reaches a position within the latch aperture B such that the arcuate surfaces 322 of the locking pins 300 exit the rearward side of the aperture B, the spring 304 affords for the locking pins 300 to extend in a generally outward direction wherein catch surfaces 328 engage the rearward surface of the latch, as shown in FIG. 10C. Although the arcuate surface 322 illustrated in the figures appear as a hemispherical surface, any arcuate surface that affords for a force to be applied thereupon when lock 10 is inserted within an aperture is within the scope of the present invention. In this manner, a self-locking cylinder lock not requiring a key to be inserted into a latch aperture and secured in a locked position is provided.

To remove the lock 10 from the latch A, the key 101 is inserted into the key tumbler mechanism 100 and rotated. Rotation of the key 101 affords for the rotation of retraction pin 110 within retraction slot 332 and retraction of locking pins 300 as illustrated in FIGS. 6 and 8. In this manner, a self-locking removable cylinder lock not requiring a key for the lock to be inserted into a latch aperture and secured in a locked position is provided.

It is appreciated that elimination for the need of a key to lock a cylinder lock in a storage unit door can reduce the difficulty of using the lock and thus affords a more user friendly locking mechanism. It is also appreciated that given a scenario in which an individual has just agreed to rent a storage unit after inspection of the unit, a manager, caretaker and/or employee of the facility can retain the cylinder lock of tie present invention at the time of the agreement, and as a service to the renter, insert the lock into the appropriate unit door after the tenant/key holder has left the premises. This feature can save the manager and the tenant time since the tenant does not have to travel back to the storage unit to lock it down after having just inspected the same unit.

The lock 10 with the key tumbler mechanism 100, tumbler-key plug 200 and locking pin 300 can be manufactured from any material known to those spilled in the art, illustratively including metals, alloys, plastics, ceramics and combinations thereof. In addition, the key tumbler mechanism 100 and locking pin assembly can be lubricated as required. Although the figures illustrate the use of two locking pins 300, the use of one locking pin 300 is within the scope of The present invention.

The foregoing drawings, discussion and description are illustrative of specific embodiments of the present invention, but they are not meant to be limitations upon the practice thereof. Numerous modifications and variations of the invention will be readily apparent to those of skill in the art in view of the teaching presented therein. It is the following claims including all equivalents which define the scope of the invention.

1. A self-locking removable cylinder lock not requiring a key for said lock to be inserted into a latch aperture and secured in a locked position, comprising:
a cylindrical tumbler-key plug having an exterior surface proportioned so that the plug fits entirely within a latch aperture; and
a locking pin positioned generally normal to a central axial axis of said tumbler-key plug; said locking pin operable to move in a generally radial inward direction without the use of a key when said plug is inserted into a latch aperture and move in a generally radial outward direction when said locking pin exits said aperture,
for the purpose of providing a self-locking removable plug cylinder lock not requiring a key for said lock to be inserted into a latch aperture and secured in a locked position.

2. The self-locking removable cylinder lock of claim 1, wherein said locking pin is spring loaded with a spring, for the purpose of applying force to said locking pin in a generally outward direction from said axial axis and allowing said locking pin to retract when force is exerted on said locking pin in a generally inward direction.

3. The self-locking removable cylinder lock of claim 2, wherein said locking pin has an external end with an arcuate surface operable to accept force in a generally inward direction towards said axial axis when in contact with a surface of a latch.

4. The self-locking removable cylinder lock of claim 2, wherein said locking pin has an external end with a catch surface, said catch surface operable to prevent removal of said lock from said latch aperture when said lock is inserted within said latch aperture and said locking pin is in an extended position.

5. The self-locking removable cylinder lock of claim 4, wherein said catch surface is L-shaped, said L-shaped surface operable to prevent said lock to be removed from said latch aperture when said locking pin is in an extended position.

6. The self-locking removable cylinder lock of claim 2, wherein said locking pin has an internal end with a spring aperture operable to accept a spring.

7. The self-locking removable cylinder lock of claim 2, wherein said locking pin has a retraction pin slot operable to accept a retraction pin.

8. The self-locking removable cylinder lock of claim 7, wherein rotation of said retraction pin within said retraction pin slot retracts said locking pin in a generally inward direction towards said axial axis of said lock.

9. The self-locking removable cylinder lock of claim 1, further comprising a keyed tumbler mechanism.

10. The self-locking removable cylinder lock of claim 1, further comprising a keyhole within said cylindrical tumbler-key plug and extending inwardly from a front end towards a rearward end and operable to accept a key.

11. The self-locking removable cylinder lock of claim 1, wherein said locking pin is proximate a rearward end of said cylindrical tumbler-key plug.

12. The self-locking removable cylinder lock of claim 1, further comprising a key operable to retract said locking pin and unlock said tumbler-key plug after said plug has been inserted into said aperture and secured in a locked position.

13. The self-locking removable cylinder lock of claim 1, wherein said cylindrical tumbler-key plug has a stationary mechanism, said stationary mechanism operable to prevent said plug from rotating once said plug is inserted into said aperture.

14. The self-locking removable cylinder lock of claim 13, wherein said stationary mechanism is a first flat region on an outer wall of said plug, said first flat region being generally parallel with a second flat region on an inner wall of a latch surrounding said aperture when said plug is inserted within said aperture.

15. The self-locking removable cylinder lock of claim 1, wherein said locking pin has an outer end, said outer end extendable and retractable beyond said exterior surface of said plug.

16. A self-locking removable cylinder lock not requiring a key for said lock to be inserted into an aperture and secured in a locked position, comprising:
a cylindrical tumbler-key plug having a front end and a rearward end and having an outer wail proportioned so that the plug fits entirely within a latch aperture;
a keyhole extending axially inward from said front end towards said rearward end;
a keyed tumbler mechanism extending axially inward from said front end towards said rearward end and operable to accept a key and rotate;
a locking pin attached to said tumbler-key plug, proximate said rearward end and positioned generally normal to an axial axis of said tumbler-key plug;
said locking pin having an outer end extendable and retractable beyond said outer wall;
said outer end having:
an arcuate surface region facing said rearward end of said tumbler-key plug and operable to push said locking pin in a generally radial inward direction when said tumbler-key plug is inserted into said aperture and said arcuate surface region contacts an inner wall of a latch surrounding said aperture; and
a catch surface region, said catch surface region facing said front end of said tumbler-key plug and operable to engage a rearward side of a latch surrounding said aperture when said tumbler-key plug is inserted into said aperture and said locking pin is in an extended position,
for the purpose of providing a self locking removable cylinder lock not requiring a key for said lock to be inserted into an aperture and secured in a locked position.

17. The self-locking removable cylinder lock of claim 16, wherein said tumbler mechanism is operable to rotate a retraction pin when a key is inserted therein and rotated.

18. The self-locking removable cylinder lock of claim 16, wherein said cylindrical tumbler-key plug has a stationary mechanism, said stationary mechanism operable to prevent said plug from rotating when said plug is inserted into said aperture and said key is inserted into said keyhole and rotated.

19. The self-locking removable cylinder lock of claim 18, wherein said stationary mechanism is a first flat region on said outer wall of said plug, said first flat region being generally parallel with a second flat region on an inner wall of a latch surrounding said aperture once said plug is inserted within said aperture.

20. The self-locking removable cylinder lock of claim 16, wherein said locking pin has a body portion between said front end and rearward end, said body portion having a retraction slot operable for accepting a retraction pin.
